(19) United States
(12) Patent Application Publication
(10) Pub. No.: US 2025/0274003 A1
(43) Pub. Date: Aug. 28, 2025

(54) ELECTRIC MOTOR AND SPRING ELEMENT

(71) Applicant: Brose Fahrzeugteile SE & Co. Kommanditgesellschaft, Würzburg, Würzburg (DE)

(72) Inventors: Michael DÜNCHER, Würzburg (DE); Daniel HIRSCH, Höchberg (DE)

(21) Appl. No.: 19/064,984

(22) Filed: Feb. 27, 2025

(30) Foreign Application Priority Data
Feb. 27, 2024 (DE) 10 2024 201 800.7

(51) Int. Cl. H02K 1/18; H02K 5/24

(52) U.S. Cl. CPC H02K 1/18; H02K 5/24

(57) ABSTRACT

An electric motor has a stator with a cylindrical stator main body with radially inwardly directed stator teeth and with a number of first axial slots formed on the circumferential side in the stator main body, and a motor housing for accommodating the stator. A number of second axial slots are provided on a housing inner wall and are arranged in alignment with the first axial slots. A spring element is provided, which has a spring main body which is inserted in a radially form-fitting manner into one of the first axial slots. A spring arm protrudes out of the spring main body and projects radially on the circumference of the stator main body. The spring arm has a stiffening contour along an arm longitudinal direction, which increases a tangential stiffness of the spring arm.

### CROSS-REFERENCE TO RELATED APPLICATION

This application claims the priority, under 35 U.S.C. § 119, of German Patent Application DE 10 2024 201 800.7, filed Feb. 27, 2024; the prior application is herewith incorporated by reference in its entirety.

### FIELD AND BACKGROUND OF THE INVENTION

The invention relates to an electric motor, in particular a steering motor for a motor vehicle, with a cylindrical stator main body with radially inwardly directed stator teeth and with a number of axial slots on the circumferential side as well as spring elements inserted or insertable therein. The invention also relates to a spring element for such an electric motor.

In a modern motor vehicle, electric motors are used in a variety of ways as drives for different actuators. Electric motors are used, for example, as window lifter, sunroof or seat adjustment drives, as steering drives (EPS, Electrical Power Steering), as radiator fan drives or as transmission actuators. Such electric motors must have a relatively high torque or power density and be reliable even at high temperatures.

An electric motor configured as an internal rotor typically comprises a stator forming the stationary motor part and a rotor forming the moving motor part. In an internal rotor motor, the stator is usually provided with a stator yoke on which stator teeth are arranged projecting radially towards the center or inwards in a star shape, the free ends of which facing the rotor surrounded by the stator form the so-called pole shoe. Windings or coils are attached to the stator teeth and are connected to the stator winding and generate a magnetic field during electromotive operation. To guide and strengthen the magnetic field generated by the energized windings, the stator material is usually metallic, for example made of soft magnetic iron.

The stator must be arranged in the motor housing to ensure operational reliability and noise-reduced motor operation, wherein both radial protection and anti-rotation protection of the stator is desired, which secures the stator against tangential rotation. The stator is therefore usually mounted in the motor housing of the electric motor by means of additional damping or decoupling elements which, in addition to securing the position, also serve to reduce structure-borne noise occurring during operation.

Spring elements in the form of decoupling springs, for example, are conceivable as damping or decoupling elements. Spring elements of this type are known, for example, from published, non-prosecuted German patent applications DE 10 2020 206 949 A1 (corresponding to U.S. Pat. No. 12,136,851) and DE 10 2022 201 621 A1. The spring elements are inserted in axial slots of the stator and are supported or damped towards the motor housing by radial spring arms. For tangential support and/or damping, the spring arms engage in axial slots in the housing inner wall at the free end, for example, so that any tangential forces that occur are damped by the tangential restoring force of the spring arms.

However, in the event of increased loads, such as a mechanical shock, the spring arms may slide at least partially out of the axial slots of the housing inner wall, so that tangential forces cannot be reliably supported or damped.

In this context, a “mechanical shock” means in particular a sudden and extreme mechanical load acting on the electric motor. In particular, a load greater than 50 g, for example between 50 g and 100 g, where g corresponds to the standard acceleration due to gravity (approximately 9.81 m/s2).

### SUMMARY OF THE INVENTION

The object of the invention is to specify a particularly suitable electric motor. In particular, reliable damping and/or decoupling of the stator with respect to a motor housing is to be ensured, even in the event of a mechanical shock. A further object of the invention is to specify a particularly suitable spring element for such an electric motor.

With regard to the electric motor, the object is achieved according to the invention with the features of the independent electric motor claim and with regard to the spring element with the features of the independent spring element claim. Advantageous embodiments and developments are the subject of the dependent claims (sub-claims). The advantages and embodiments cited with regard to the electric motor can also be applied, mutatis mutandis, to the spring element and vice versa.

The electric motor according to the invention is configured, for example, as a synchronous motor, in particular as a steering motor for a motor vehicle. The electric motor or steering motor is in particular part of a steering drive (Electrical Power Steering, EPS).

The brushless electric motor has a stator with a cylindrical stator main body with radially inwardly directed stator teeth and with a number of first axial slots formed on the circumferential side in the stator main body. A “first axial slot” is understood here and in the following to mean in particular a radially inwardly directed slot or slot-like recess on the outer circumference of the stator main body, with the slot longitudinal direction extending along the axial direction and the slot width direction extending along the tangential direction of the stator.

Here and in the following, “axial” or an “axial direction” is understood in particular to mean a direction parallel (coaxial) to the axis of rotation of the electric motor, i.e., perpendicular to the end faces of the stator. Accordingly, “radial” or a “radial direction” is understood here and in the following to mean in particular a direction perpendicular (transverse) to the axis of rotation of the electric motor along a radius of the stator or the electric motor. Here and in the following, “tangential” or a “tangential direction” is understood in particular to mean a direction along the circumference of the stator or the electric motor (circumferential direction, azimuthal direction), i.e., a direction perpendicular to the axial direction and the radial direction.

The stator main body is designed, for example, as a solid body, in a so-called single-tooth design or in a star-yoke design, in which the stator teeth are inserted into a cylindrical stator yoke, for example as a star ring.

A motor shaft (rotor shaft) with a shaft-fixed rotor is preferably rotatably mounted in the stator. The electric motor has a motor housing in which the stator and rotor are accommodated.

The motor housing has a housing inner wall facing the stator main body, in which a number of second axial slots are provided. Here and in the following, a “second axial slot” is to be understood in particular as a radially outwardly directed depression, groove, shaping, slot or slot-like recess on the inner circumference of the motor housing, wherein the slot longitudinal direction extends along the axial direction and the width of the slot extends along the tangential direction of the electric motor or motor housing.

The number of first and second axial slots is preferably the same, which means that each first axial slot of the stator is assigned a second axial slot of the motor housing. The first and second axial slots are arranged in radial alignment with each other. In other words, the first and second axial slots are arranged opposite one another, with a radial distance or a radial clearance being provided between the first and second axial slots.

The electric motor or its stator has at least one spring element. Preferably, the electric motor has a number of spring elements corresponding to the number of first axial slots.

The spring elements of the present invention are based on the earlier published, non-prosecuted German patents DE 10 2020 206 949 A1 and DE 10 2022 201 621 A1. Their disclosure, in particular their claims (with associated explanations) are hereby expressly incorporated by reference in the instant application. The content of these applications is therefore fully incorporated by reference in the present application.

Each spring element has, for example, a plate-shaped spring main body, which is inserted or can be inserted in a radially form-fitting manner into one of the first axial slots. The or each first axial slot is configured as a radial undercut or as a radial notching of the stator main body outer circumference. As a result, a reliable and operationally safe radially form-fitting mounting or fixing of the spring element in the first axial slot is realized in a structurally simple manner.

The spring element, which preferably acts as a decoupling or damping element and is inserted into the respective first axial slot of the stator main body on the yoke or back-iron side, in particular by pushing or inserting it in the axial direction, engages behind the undercut formed in the first axial slot. For this purpose, the respective first axial slot is dovetail-shaped or T-shaped in cross-section, for example. Other shapes (cross-sectional shapes) of the first axial slot are also conceivable, for example a semi-circular shape or a T-shape with a local elevation or a local depression (bead) in the slot base of the horizontal T-leg of the first axial slot.

For example, a first axial slot is used as described in international patent disclosure WO 2020/249555 A1, corresponding to U.S. Pat. No. 12,136,851. Its disclosure, in particular its claims (with associated explanations) are hereby expressly incorporated by reference in the present application. With regard to the radial undercut of the first axial slot, specific reference is made to claims 2 and 3 with the associated explanations, in particular on pages 3/4 and 8/9, and to FIGS. 6 to 12.

The spring main body has at least one spring arm (spring tab, radial spring) protruding or bent out of it, which projects radially on the circumference of the stator main body when inserted into the corresponding first axial slot. The number of spring arms of the spring element or the spring main body is selected, for example, as a function of the length of the stator main body (stator length) and preferably increases with increasing stator length.

According to the invention, the spring arm has a stiffening contour along a (spring) arm longitudinal direction, which increases the tangential stiffness of the spring arm, i.e., the stiffness in the (spring) arm width direction. In particular, the stiffening contour increases the bending resistance of the spring arm to tangential loads or loads directed in the arm width direction.

In the assembled state, the spring arm engages at least partially radially and tangentially in one of the second axial slots on the free-end side. This creates a particularly suitable electric motor.

A “form fit” or a “form-fitting connection” between at least two interconnected parts is understood here and in the following to mean in particular that the interconnected parts are held together at least in one direction, in this case the radial and tangential direction in relation to the central axis of the stator and the axis of rotation of the electric motor, by a direct interlocking of the contours of the parts themselves. The “locking” of a mutual movement in this direction is therefore shape-related.

In the assembled state, the spring element engages both in the first axial slot of the stator and in the second axial slot of the motor housing. The spring arm or the arm longitudinal direction is inclined at a particularly acute angle of inclination to the spring main body, so that the spring arm rests radially resiliently on the motor housing or on a base of the second axial slot due to the radial form fit, so that radial forces occurring during operation can be reliably decoupled or damped. The material thickness and the angle of inclination of the spring arm to the spring main body can be used, for example, to preset or adjust the characteristic curve of the spring arm, i.e., the ratio between spring force and spring travel.

In the assembled state, the spring end or free end of the spring arm rests form-fittingly and/or with frictional engagement against the motor housing or in the second axial slot. The spring arm also acts as a primary protection against mechanical rotation of the stator along the tangential direction.

Due to the tangential form fit of the spring arm with the axially oriented side walls of the second axial slot, tangential forces occurring during operation are introduced into the spring arm as shear forces and thus damped or decoupled. The spring arm has an arm width that substantially corresponds to the width of the second axial slot, so that a reliable tangential form fit with as little play as possible is ensured. It is recognized that the spring arm width is also decisive for the tangential stiffness or restoring force of the spring arm. The tangential stiffness of the spring arm is increased by the stiffening contour extending along the arm longitudinal direction, which consequently improves the fixation and contact stiffness of the spring arm in the second axial slot. This advantageously reduces the risk of the spring arm slipping or sliding out of the second axial slot under increased load. This enables reliable decoupling or damping even in the event of a mechanical shock.

The stiffening contour has substantially no effect on the radial stiffness or spring constant of the spring arm. In other words, the stiffening contour only has a minor influence on the radial stiffness of the spring arm, as this is substantially dimensioned by the angle of inclination to the spring main body and by the material thickness.

The improved hold of the spring arm in the second axial slot caused by the stiffening contour is independent of the housing material and/or the machining process of the second axial slot. In other words, the retention of the spring arm does not depend substantially on the roughness of the housing inner wall or the second axial slot. As a result, housing tolerances have less influence on the spring element or the decoupling or damping realized as a result.

The spring elements are used to decouple the stator in the motor housing from structure-borne noise while maintaining sufficient radial and/or tangential rigidity. By specifically adapting or designing the radial and tangential (spring) stiffness of the spring elements used, the requirements for structure-borne noise generated by the transmission of vibrations to the motor housing as a result of electromagnetic excitation from the stator are met.

This improves the acoustic properties of the electric motor during motor operation, as the oscillations and/or vibrations generated by the stator are not transmitted to the motor housing as structure-borne noise due to the spring elements.

The spring element improved by the stiffening contour thus ensures a radial and tangentially resilient (de-) coupling or damping of the stator to the motor housing that is always reliable and operationally safe. In particular, the stator is thus better fixed in the motor housing under shock loads. The electric motor therefore has improved robustness against mechanical loads, in particular against mechanical shock. Furthermore, the spring elements also ensure particularly stable anti-rotation protection with regard to mechanical rotation of the stator in the motor housing.

The design of the spring element according to the invention is also more robust with regard to tolerances, for example with regard to assembly tolerances when installing the stator in the motor housing. In other words, any tolerances that occur have only a minor or negligible effect on the decoupling and damping realized by the spring element. This simplifies the assembly of the electric motor.

In one conceivable embodiment, the spring element has, for example, at least one clamping claw or claw lug on one longitudinal side of the main spring body to improve tangential and/or axial fastening or fixing in the first axial slot. The respective clamping claw is suitably bent up out of the plane of the spring main body of the spring element. This achieves a reliable fixing (mounting, fastening) of the spring element in the first axial slot of the stator main body assigned to it. This means that the spring element is configured with a gripping design in order to grip tangentially and/or axially in the first axial slot. This ensures reliable form-fitting and/or frictionally engaged fixing of the spring element in a tangential direction. Preferably, the clamping claws or claw lugs are arranged in pairs on the opposite longitudinal sides of the spring main body.

The conjunction “and/or” is to be understood here and in the following in such a way that the features linked by means of this conjunction can be formed both together and as alternatives to each other.

A “frictional engagement” or a “frictionally engaged connection” between at least two parts connected to each other is understood here and in the following to mean in particular that the parts connected to each other are prevented from sliding against each other due to a frictional force acting between them. In the absence of a “connecting force” that causes this frictional force (this means the force that presses the parts against each other, for example a screw force or the weight force itself), the frictionally engaged connection cannot be maintained and can therefore be released.

In a preferred embodiment, the second axial slots are introduced into the housing inner wall by a joining process of the stator into the motor housing. In other words, the motor housing or the housing inner wall is manufactured without the second axial slots, and the axial slots are introduced into the housing inner wall by the stator when the stator is inserted into the motor housing. In particular, the second axial slots are formed, for example embossed, scratched or molded, by the spring arms of the spring elements that lie radially against the housing inner wall. This makes it particularly easy and practical to produce the second axial slots. In particular, it is thus always ensured that the second axial slots are radially aligned and parallel to the first axial slots, so that reliable mounting and fixing of the stator within the motor housing is ensured. It is conceivable that the stiffening contour is configured in such a way that it also supports the reliable insertion of the second axial slots.

In an alternative embodiment, it is also conceivable, for example, that the second axial slots are introduced into the housing inner wall by machining or with the use of tools before the joining process. The second axial slots are therefore already present as mating contours before the stator is inserted. Controlled production makes it possible to strengthen the holding effect of the spring arms or to make it more defined, so that a more stable mounting and support of the stator within the motor housing is achieved.

In an advantageous embodiment, the stiffening contour is designed in such a way that it converts a tangential support force in the second axial slot, i.e., a tangential force or shear force acting on the spring arm, at least partially into a radial force acting along the radially arranged spring arm.

By converting the tangential force into a tangential and radial ratio, the stiffening contour creates a self-locking effect that counteracts a loss of contact between the spring arm and the second axial slot. The stiffening contour enables the spring element or spring arm to maintain or lock its position in the second axial slot. The spring arm or the stiffening contour is therefore designed in such a way that it locks automatically or remains in this position when a tangential load is applied.

In a preferred embodiment, the stiffening contour is substantially V- or U-shaped, so that the spring arm has an approximately V- or U-shaped cross-sectional form in a cross-sectional plane perpendicular to the arm longitudinal direction. In other words, the side edges are bent, curved, angled or kinked with respect to a center line running parallel to the arm longitudinal direction, for example. The stiffening legs (U-legs, V-legs) thus formed in cross-section, i.e., the side edges of the spring arm, form the contact surface in the second axial slot. In other words, the spring arm preferably rests only in the area of the free ends of the stiffening legs.

This design ensures reliable self-locking and conversion of a tangential force into a tangentially and radially directed force. In the event of a tangentially acting load, the stiffening legs are at least partially moved towards each other, resulting in radially directed force components along the leg longitudinal direction. Accordingly, the spring or restoring force acts in both the tangential and radial directions, which supports self-locking.

By dimensioning the angle of inclination of the stiffening legs in relation to the spring main body, a radial proportion of the reaction or restoring force can be adjusted or predetermined. The greater the angle of inclination, the greater the radial component in the reaction force, which is triggered by a load, for example by a (mechanical) shock. The angle of inclination is, for example, less than 10°, in particular between 8° and 5°, preferably around 6°. The exact value for a suitable angle of inclination depends on many factors (material pairing of spring element and motor housing, surface roughness of the motor housing, surface tension, temperature range during normal operation of the electric motor, edge properties of the stiffening legs, material post-treatment, hardness, . . . ), and is selected specifically for the respective application or for the respective electric motor.

The spring arm rests resiliently against the motor housing or the second axial slot at the free end, in particular in the area of the free ends of the stiffening legs. In an expedient development, the free end of the spring arm is convexly curved with respect to the second axial slot. The convex bend creates a rounded contact surface of the spring arm on or in the second axial slot, so that simple axial insertion or introduction of the free end of the spring arm into the second axial slot is possible.

In one conceivable design, the stiffening contour extends beyond the bend. Due to the bend and the stiffening shape, the free end of the spring arm preferably has an approximately saddle-shaped or anticlastically curved geometry. This further stabilizes the free end, in particular the contact surfaces formed by the free ends of the stiffening legs, against tangential loads. This ensures particularly stable engagement or contact with the second axial slot.

In one possible embodiment, the respective spring element is designed as a one-piece, i.e., a one-part or monolithic, stamped and bent part. One-piece means in particular that the at least one spring arm is made in one piece with the spring main body. This results in a particularly cost-effective and component-reduced design of the spring element, which has a beneficial effect on the manufacturing costs of the electric motor.

In an advantageous development, the stiffening contour is embossed into the spring arm. In other words, the stiffening contour is embossed into the spring arm. The stiffening contour is configured, for example, as a bead-shaped indentation in the spring arm.

Preferably, the spring element has a coupling spring on a narrow side or end face of the spring main body, which coupling spring protrudes axially from the first axial slot. The first axial slot extends substantially over the entire axial length of the stator, so that the coupling spring protrudes axially from a stator end face and is resiliently supported axially at the free end on a housing cover of the motor housing. Due to the coupling spring, the spring element is thus also provided for axial mounting and fixing of the stator in a motor housing and is suitable and set up for this purpose. A particularly practical design is one in which the coupling spring connects to the spring main body via a radially raised bending section or one that protrudes from the plane of the spring main body, in particular an approximately S-shaped bending section, forming a contact edge. With this contact edge, the spring element is in contact with an end face of the stator main body, preferably in the form of a line contact.

The spring element according to the invention is provided for an electric motor described above and is suitable and set up for this purpose. The spring element is configured in particular as a decoupling and damping element for mounting the stator in the motor housing and, in the assembled state, also provides tangential anti-rotation protection of the stator within the motor housing. For this purpose, the spring element has, for example, a plate-shaped spring main body from which at least one spring arm protrudes or is bent out. The spring arm is arranged at an angle of inclination to the spring main body, so that the spring arm protrudes radially on the circumference of the stator in the assembled state. According to the invention, the spring arm has a stiffening contour along the arm longitudinal direction, which increases the tangential stiffness of the spring arm, i.e., stiffness in the arm transverse direction. This results in a particularly suitable spring element for an electric motor, especially for a steering motor.

Other features which are considered as characteristic for the invention are set forth in the appended claims.

Although the invention is illustrated and described herein as embodied in an electric motor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective view of an electric motor with a motor housing and an end shield according to the invention;

FIG. 2 is a perspective view of a stator and a rotor of the electric motor;

FIG. 3 is a sectional view of a detail of the electric motor;

FIG. 4 is a perspective view of a spring element;

FIG. 5 is a side view of the spring element;

FIG. 6 is a plan view of the spring element;

FIG. 7 is a front view of the spring element with a view of a rear side; and

FIGS. 8A, 8B are schematic sectional views of a motor housing and the spring element under a tangential load.

Corresponding parts and sizes are always marked with the same reference signs in all figures.

### DETAILED DESCRIPTION OF THE INVENTION

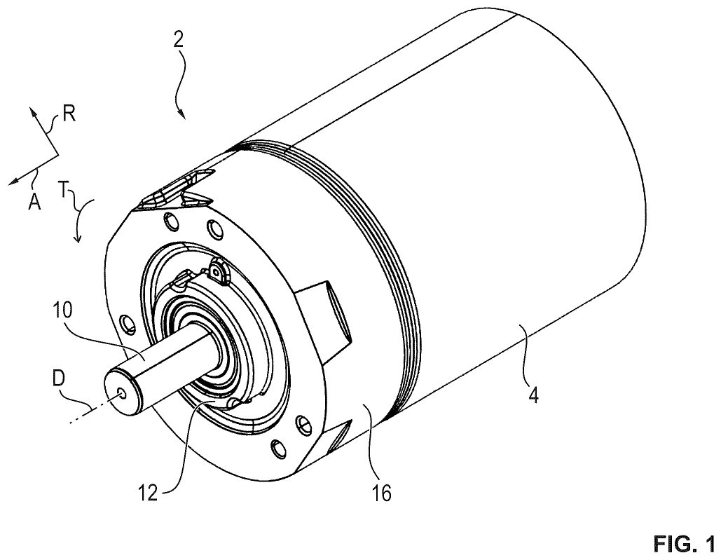

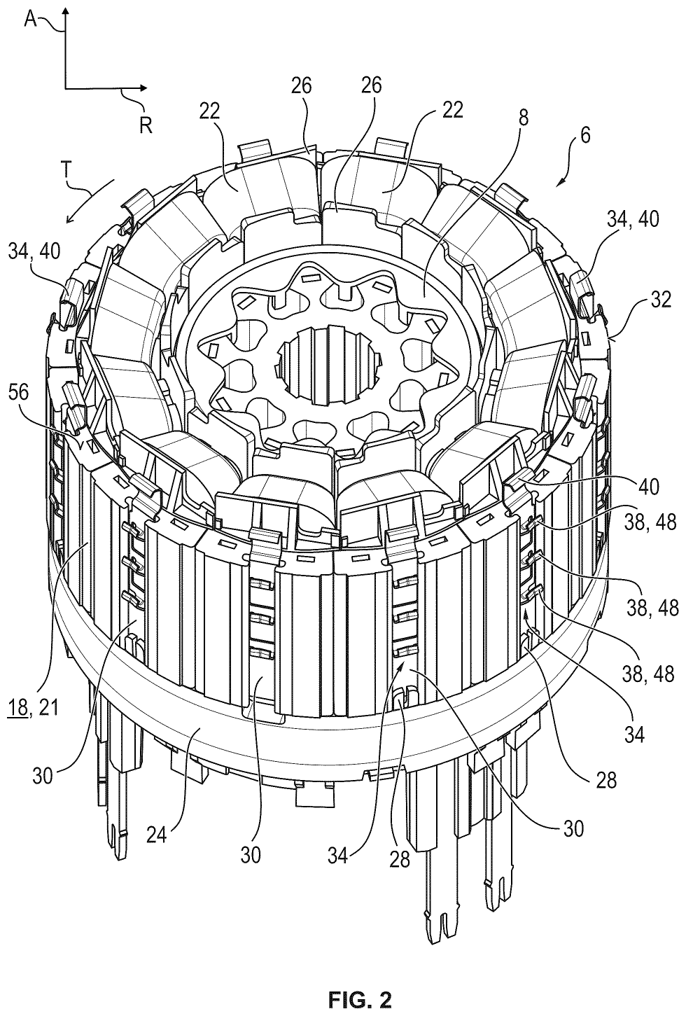

Referring now to the figures of the drawings in detail and first, particularly to FIG. 1 thereof, there is shown an electric motor 2 which has a motor housing 4 with a stator 6 and rotor 8 (see FIG. 2) arranged in it.

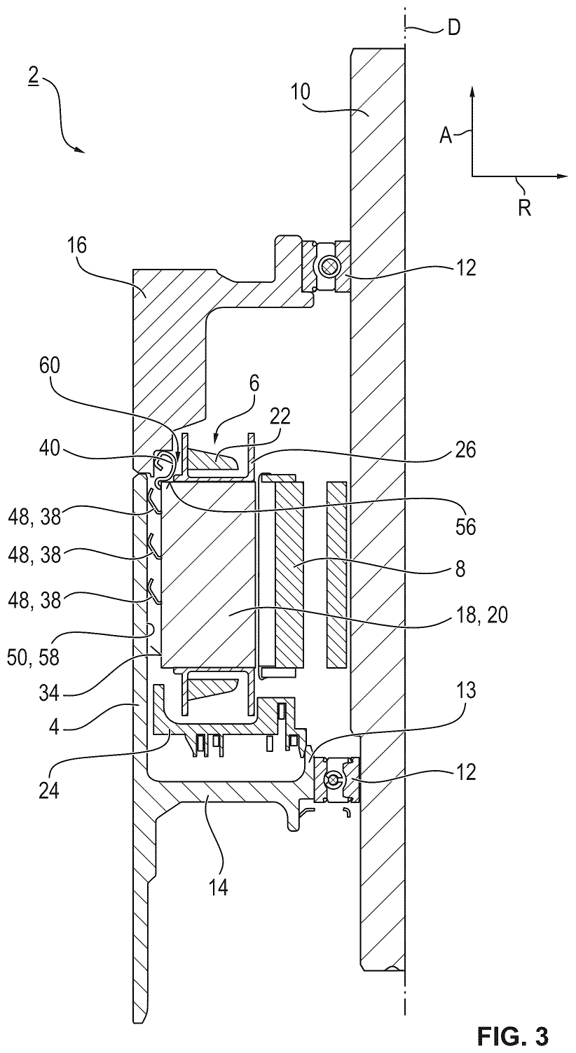

The electric motor 2, which is configured as a permanently excited synchronous motor, for example, is designed as an internal rotor in this exemplary embodiment. The rotor 8 is joined to a motor shaft 10 in a shaft-fixed manner. The motor shaft 10 is rotatably mounted in the motor housing 4 by means of two bearings 12. The bearings 12 are configured as ball bearings, for example. One of the bearings 12 is arranged in a bearing seat 13 of a housing base 14 of the motor housing 4, which is designed as a (housing) partition wall (see FIG. 3). The other bearing 12 is arranged in an end shield 16, which is placed axially on the cup-shaped motor housing 4 as a housing cover on the end face opposite the housing base 14.

The stator 6 shown in greater detail in FIG. 2 and FIG. 3 has a stator main body 18. In the illustrated exemplary embodiment, the stator main body 18 is designed with twelve stator teeth 20, which extend inwards in a radial direction R (radially) in the direction of the central axis of rotation D of the electric motor 2 shown in the drawing.

The stator main body 18 has a stator yoke 21 or back iron, which surrounds the stator teeth 20 on the circumference. In the exemplary embodiment shown, the stator main body 18 has a so-called single-tooth design, in which the stator 6 or its stator main body 18 is composed of individual stator teeth 20. In an alternative exemplary embodiment, not shown, the stator main body 18 is designed in a star yoke design, in which the stator yoke 21 is a separate component and the stator teeth 20 form a so-called stator star, which is inserted into the stator yoke 21. The stator 6 or the stator main body 18 or the stator teeth 20 are designed, for example, as a solid body or are constructed as stamped laminated stacks of individual sheets.

Between the stator teeth 20, unspecified free spaces are formed in which the windings of (stator) coils 22 are accommodated, which are connected to one another by means of an end-face interconnection ring (contact unit) 24, for example in a star or delta connection, forming a stator or rotating field winding.

The coils 22 are arranged on insulating coil formers 26, which are placed on the stator teeth 20 (FIG. 3). The coils 22 and coil formers 26 are only provided with reference signs as examples in the figures. The interconnection ring 24 is placed on the end face of the stator main body 18 and secured in the (first) axial slots 30 by means of latching tongues 28. The latching tongues 28 act here as positioning or centering lugs.

The axial slots 30 are formed in an outer circumference 32 of the stator main body 18, i.e., on the outer circumference side, as slots or recesses in the stator main body 18 extending in the axial direction A and radially inwards towards the axis of rotation D. The respective axial slot 30 is designed in particular as a dovetail-shaped or T-shaped radial undercut of the outer circumference 32.

A spring element 34 is inserted radially and tangentially in the axial slots 30. The axial slots 30 and spring elements 34 are only provided with reference signs as examples in the figures.

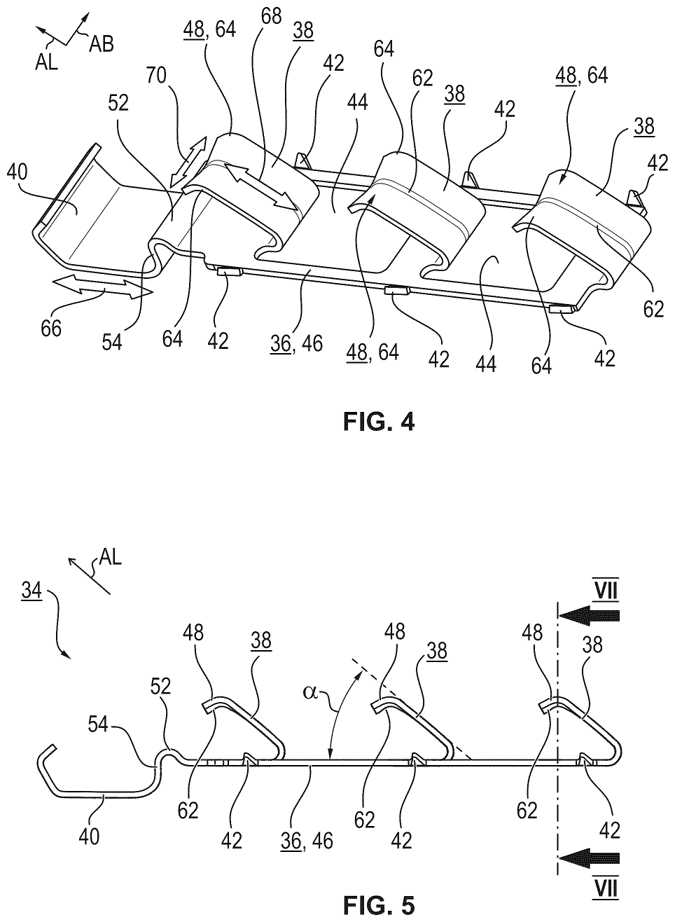

The spring element 34 shown individually in FIGS. 4 to 7 has a plate-shaped spring main body 36 to which three spring arms 38 as radial and tangential springs, a coupling spring 40 as axial spring, and three pairs of clamping claws 42 are molded integrally, i.e., in one piece or monolithically.

The spring element 34 is designed in particular as a stamped and bent part, wherein the spring arms 38, coupling spring 40 and clamping claws 42 protrude or are bent out of the spring main body 36.

The coupling spring 40, which is axially aligned in the assembled state, is designed in particular as a resilient (spring) tab that is bent in an approximately C- or U-shape. The coupling spring 40 is arranged on a narrow side or end face of the substantially rectangular spring main body 36.

The resilient spring arms 38 are formed as punched tabs out of the spring main body 36 and are bent out of the plane of the spring main body 36 in a C- or U-shape. Two of the spring arms 38 are inserted into the spring main body 30 for this purpose, so that two window-like punched openings or recesses 44 are formed in the spring main body 36. The third spring arm 38 is formed on a narrow side or end face of the spring main body 36 opposite the coupling spring 40 and bent out over the spring main body 36.

The spring element 34 has an unspecified spring longitudinal direction and spring transverse direction, wherein the spring longitudinal direction is parallel to the axial direction A and the spring transverse direction is substantially parallel to a tangential direction T in the assembled state. The spring main body 36 is arranged in the plane spanned by the longitudinal and spring transverse directions.

The spring arms 38 are bent up at an angle of inclination α relative to the spring base 36. The angle of inclination α is an acute angle, for example approximately 40°, in particular 40°±5°. The spring arms 38 each extend along an arm longitudinal direction AL and an arm width direction (arm transverse direction) AB. The arm width direction AB runs parallel to the spring transverse direction or tangential direction T. The arm longitudinal directions AL of the spring arms 38 are arranged parallel to each other, at least in the relaxed spring state.

The arm longitudinal direction AL is accordingly inclined or tilted by the angle of inclination α in relation to the spring longitudinal direction or axial direction A, so that the arm longitudinal direction AL also has a component along the radial direction R in relation to the assembled state. As a result, the spring arms 38 also act as radial springs.

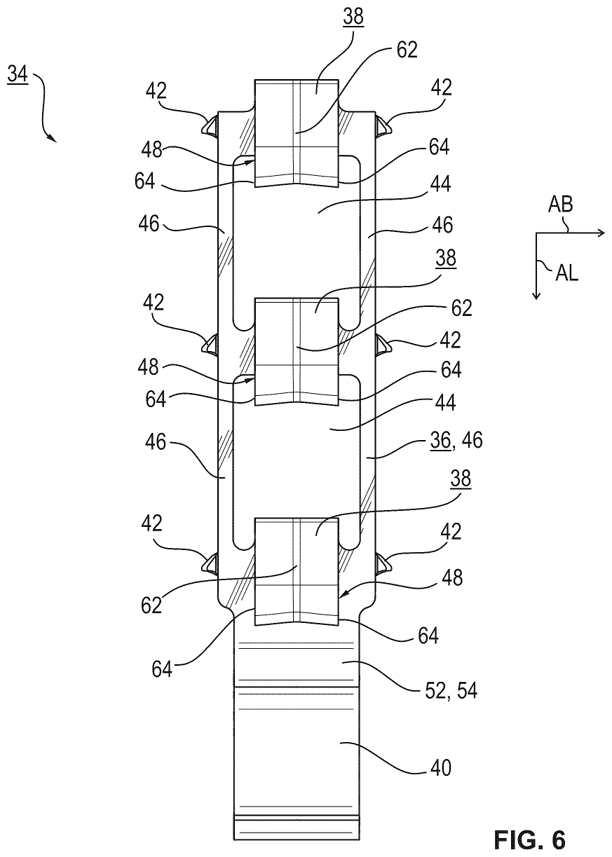

The spring main body 36 protrudes beyond the spring arms 38 in the spring transverse direction or tangential direction T and, at least for the two punched-out spring arms 38 inside the spring main body 36, also in the spring longitudinal direction or axial direction A. The spring main body 36 thus protrudes laterally on both sides of the spring arms 38 in the circumferential or tangential direction T, as can be seen comparatively clearly in FIG. 6. The projection (connecting web, attachment web) 46 on both sides engages behind slot flanks formed within the axial slot 30 in the assembled state, so that the spring element 34 is form-fittingly fixed in the axial slot 30 in the radial and tangential direction. In other words, the slot flanks form an undercut for the spring element 34 inserted axially into the axial slot 30.

Three clamping claws or clamping teeth 42 are formed on the outside of the projections 46 on both long sides of the spring base 36 of the spring element 34 as approximately triangular claw lugs. The clamping claws 42 are bent out of the plane of the spring base 36 in the direction of the raised spring arms 38. In the assembled state, the clamping claws 42 clamp in a frictionally engaged manner with the slot flanks of the axial slot 30 and thus secure the main spring body 36 or the spring element 34 to the stator 6 so that it cannot be lost.

The spring arms 38 or the angles of inclination α are oriented open in the direction of the end shield 16 in the assembled state and project radially from the axial slot 30 in the direction of the motor housing 4. The spring element 34 thus has an approximately fir-tree or sawtooth-shaped geometry in side view (FIG. 3, FIG. 5). For assembly, the stator 6 is inserted axially into the motor housing 4, wherein the spring arms 38 each engage with their respective free ends 48 in a (second) axial slot 50 of the motor housing 4. During insertion, the free ends 48 slide along in the axial slots 50 and are radially compressed or tensioned in the direction of the axis of rotation D or in the direction of the spring main body 36. The raised spring arms 38 thus also act as an insertion aid for positioning the stator 6 in the motor housing 4.

An approximately U-shaped bending point 52 is provided between the narrow side of the spring main body 34 and the coupling spring 40, which is bent out of the plane of the spring main body 34 first in the direction of the spring arms 38 and then in the opposite direction, wherein a vertical U-leg 54 of the bending point 52 merges or opens into the approximately U-shaped bend of the coupling spring 40. The U-leg 54 forms a contact edge or contact surface which extends substantially from the plane of the spring main body 36 on the side of the spring main body 36 opposite the spring arms 38 in the radial direction R. With this contact edge or contact surface of the U-shaped leg 54, the spring element 34—as can be seen in FIG. 3, for example—is in contact with an end face 56 of the stator main body 18 or its stator yoke 21 facing the end shield 16 in the assembled state inserted into the respective axial slot 30.

In the assembled state, the coupling spring 40 extends axially beyond the axial slot 30 and the end face 56 of the stator main body 18. The coupling spring 40 is arranged in particular on the end face 56 of the stator main body 18 opposite the interconnection ring 24.

As can be seen in particular in FIG. 3, the stator 6 rests in the axial slots 50 of the motor housing 4 via the radially protruding spring arms 38 of the spring elements 34, which thus project beyond the stator 6 on the outer circumference 32 in the radial direction R. In particular, the spring arms 38 rest resiliently or hingedly in the axial slots 50 in the region of their free ends 48. In this way, the stator 6 is decoupled from the motor housing 4 of the, for example, 10-pole electric motor 2.

The stator 6 also bears on the end face of the end shield 16 via the coupling springs 40 of the spring elements 34, and is therefore also decoupled or damped relative to the end shield (FIG. 3). The coupling springs 40 are supported here by means of the U-shaped legs 54 on the end face 56 and are compressed or bent at the free end on one edge of a spring installation space 60 towards the end shield 16. In this way, the stator 6 is decoupled from the motor housing 4 or the end shield 16.

The free ends 48 of the spring arms 38 and the free end of the coupling spring 40 are bent or curved towards the plane of the spring main body, so that a rounded, convex contact surface is formed in each case against the axial slot 50 or the end shield 16.

The axial slots 50 are designed as radially outwardly directed slots or slot-like recesses on an inner circumference of a housing inner wall 58 of the motor housing 4, with the slot longitudinal direction extending along the axial direction A and the slot width direction extending along the tangential direction T of the electric motor 2 or motor housing 4.

The axial slots 50 have a slot width that substantially corresponds to the arm width of the spring arms 38 or the free ends 48, so that the free ends 48 are radially form-fitted on a tangentially oriented slot base and tangentially form-fitted between the approximately radially oriented slot side walls or slot flanks.

Preferably, the free ends 48 introduce the axial slots 50 into the housing inner wall 58 when the stator 6 is inserted or joined to the motor housing 4. In other words, the free ends 48 scratch, emboss or form the axial slots 50 into the housing inner wall 58 when sliding along the housing inner wall 58, so that the free ends 48 automatically engage in the axial slots 50 and are guided therein. Alternatively, the axial slots 50 are machined into the inner wall 58 of the housing, for example as slot-like millings, before the stator 6 is inserted.

The spring arms 38 each have a stiffening contour 62, which extends along the respective arm longitudinal direction AL. The stiffening contour 62 is arranged in the middle or centrally with respect to the arm width. In other words, the stiffening contour 62 extends along an axis of symmetry of the spring arm 38. The stiffening contour 62 also supports, for example, the introduction of the axial slots 50 into the inner wall 58 of the housing when the stator 6 is joined to the motor housing 4.

The stiffening contour 62 is formed as a bead-like embossing in the respective spring arm 38. The stiffening contour 62 extends here over the curved free end 48, so that the free end 48 has an approximately saddle-shaped or anticlastically curved geometry.

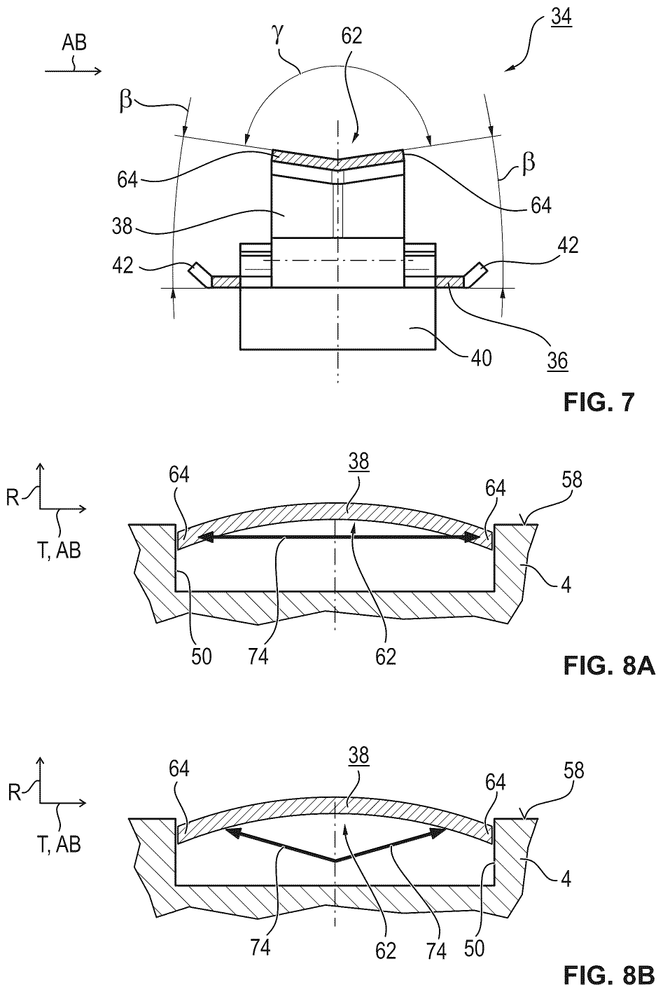

As can be seen, for example, in the frontal view of FIG. 7, the spring arm 38 has an approximately U-shaped or V-shaped cross-sectional shape in a sectional plane oriented perpendicular to the arm longitudinal direction AL due to the stiffening contour 62. In other words, the stiffening contour 62 is U-shaped or V-shaped. The side edges of the spring arm 38, which are bent up or raised as a result, thus form stiffening legs (U-legs, V-legs) 64 of the stiffening contour 62. The stiffening legs 64 form the contact surfaces or the mechanical points of contact with the axial slot 50 or its slot side walls (FIGS. 8A, 8B), at least in portions.

In the exemplary embodiment shown, the stiffening legs 64 are bent in particular in a V-shape. For example, the stiffening legs 64 have an angle of inclination β with respect to the spring main body 36 of the arm width direction AB of less than 10° and, for example, more than 6°. In the embodiment shown, the angle of inclination β is dimensioned, for example, to approximately 8°, in particular to 8°+4°. An opening angle γ between the stiffening legs 64 thus has an obtuse angle value, which is approximately 164° in the exemplary embodiment shown. The angle of inclination β substantially determines an angle of friction with the housing inner wall 58 or the axial slot 50.

The stiffening contour 62 increases the stiffness or the bending resistance of the spring arm 38 against tangential loads or loads directed in the arm width direction AB.

During operation of the electric motor, the electromagnetic forces generated cause structure-borne noise from the stator 6. This structure-borne noise is damped by the spring elements 34 so that it is transmitted to the motor housing 4 minimally or not at all. The spring elements 34 thus decouple the structure-borne noise of the stator 6 from the motor housing 4. As shown schematically in FIG. 4 by means of double arrows, the coupling spring 40 realizes axial suspension (damping, decoupling) 66, and the spring arms 38 each realize a radial suspension 68 and a tangential suspension 70. The radial suspension 68 is realized in particular by changing the spring arm position 38, i.e., by changing the angle of inclination α.

The stiffening contour 62 increases the spring stiffness of the tangential suspension 70, whereby the spring arm 38 sits more stably in the axial slot 50. The stiffening provided by the stiffening contour 62 is dimensioned in such a way that the spring arm 38 does not slide or jump out of the axial slot 50 even in the event of a mechanical shock. As a result, the spring arms 38 also ensure that the stator 6 in the motor housing 4 is secured against twisting in a particularly reliable manner.

In particular, the stiffening contour 62 realizes self-locking and conversion of a tangential force 72 into a tangentially and radially directed force 74. As shown in the schematic and simplified representations of FIG. 8A and FIG. 8B, when a tangential force (tangential support force) 72 acts on the spring leg 38 as a shear or transverse force, the stiffening legs 64 are at least partially moved towards each other, so that radially directed force components are produced along the stiffening legs 64. Accordingly, the spring or restoring force thus acts in both a tangential and radial direction.

The invention is not limited to the exemplary embodiment described above. Rather, other points of the invention can also be derived from it by a person skilled in the art without departing from the subject matter of the invention. In particular, the individual features described in conjunction with the exemplary embodiment can also be combined with one another in other ways without departing from the subject matter of the invention.

The electric motor 2 shown in the exemplary embodiment is, in particular, a steering motor of a motor vehicle. The solution described above can be used not only in the specific application shown, but also in a similar design in other motor vehicle applications, such as electric brake motors, door and tailgate systems, window lifters, as well as electric drives and their arrangement in the vehicle or other electric machines and systems.

The following is a summary list of reference numerals and the corresponding structure used in the above description of the invention:
2 electric motor
4 motor housing
6 stator
8 rotor
10 motor shaft
12 bearing
13 bearing seat
14 housing base
16 end shield
18 stator main body
20 stator tooth
21 stator yoke
22 stator coil
24 interconnection ring
26 coil former
28 latching tongue
30 axial slot
32 outer circumference
34 spring element
36 spring main body
38 spring arm
40 coupling spring
42 clamping claw
44 recess
46 projection
48 free end
50 axial slot
52 bending point
54 u-leg
56 end face
58 housing inner wall
60 spring installation space
62 stiffening contour
64 stiffening leg
66 spring effect
68 spring effect
70 spring effect
72 tangential force
74 force
A axial direction
R radial direction
T tangential direction
D axis of rotation
AL arm longitudinal direction
AB arm width direction
a angle of inclination
B angle of inclination
Y opening angle

1. An electric motor, comprising:
a stator having a cylindrical stator main body with radially inwardly directed stator teeth and with a plurality of first axial slots formed on a circumferential side in said stator main body;
a motor housing accommodating said stator and having a housing inner wall, wherein a plurality of second axial slots are formed on said housing inner wall, and are disposed in alignment with said first axial slots; and
at least one spring element having a spring main body inserted in a radially form-fitting manner into one of said first axial slots, said at least one spring element further having at least one spring arm which protrudes or is bent out of said spring main body and projects radially on a circumference of said cylindrical stator main body, wherein said at least one spring arm has a stiffening contour along an arm longitudinal direction, which increases a tangential stiffness of said at least one spring arm, and wherein said at least one spring arm engages radially and tangentially in a form-fitting manner at least in portions in one of said second axial slots at a free end.

2. The electric motor according to claim 1, wherein said second axial slots are formed in said housing inner wall by a joining process of said stator into said motor housing.

3. The electric motor according to claim 1, wherein said stiffening contour is configured such that a tangential support force in a second axial slot of said second axial slots is at least partially converted into a radial force acting along said at least one spring arm.

4. The electric motor according to claim 1, wherein said stiffening contour is substantially V-shaped or U-shaped in cross-section, and has stiffening legs formed thereby forming a contact surface in a second axial slot of said second axial slots.

5. The electric motor according to claim 1, wherein said at least one spring arm has a convexly shaped bend at said free end with respect to said second axial slots as a contact surface.

6. The electric motor according to claim 5, wherein said stiffening contour extends over said convexly shaped bend.

7. The electric motor according to claim 1, wherein said at least one spring element is configured as a one-piece stamped and bent part.

8. The electric motor according to claim 1, wherein said stiffening contour is embossed into said at least one spring arm.

9. The electric motor according to claim 1, wherein:
said motor housing has a housing cover; and
said at least one spring element has a coupling spring on a narrow side of said spring main body, said coupling spring projects axially from a first axial slot of said first axial slots and is resiliently supported at said free end on said housing cover of said motor housing.

10. The electric motor according to claim 1, wherein the electric motor is a steering motor.

11. A spring element for an electric motor, comprising:
a spring main body; and
at least one spring arm protruding or bent out of said spring main body, said at least one spring arm having a stiffening contour along an arm longitudinal direction and increases a tangential stiffness of said at least one spring arm.
